(19) United States
(12) Patent Application Publication
(10) Pub. No.: US 2026/0051721 A1
(43) Pub. Date: Feb. 19, 2026

(54) ANTI-PISTONING DEVICE

(71) Applicant: Preformed Line Products Company, Cleveland, OH (US)

(72) Inventors: John Bentley, Hampshire (GB); Andy Parr, Hampshire (GB); Simon Clinton, Hampshire (GB)

(21) Appl. No.: 18/802,270

(22) Filed: Aug. 13, 2024

(51) Int. Cl. H02G 1/06

(52) U.S. Cl. CPC H02G 1/06

(57) ABSTRACT

An anti-pistoning device includes a body having a wall defining a first cavity and a second cavity, wherein the first cavity is dimensioned to receive an outer sheath of a cable, and the second cavity is dimensioned to receive an inner sheath of a cable.

### FIELD OF INVENTION

The present disclosure relates to a device for cables, and more specifically, an anti-pistoning device for cables.

### BACKGROUND

Installing cable networks (e.g., fiber optic, power, telecom, etc.) can be an arduous process considering the expansive length of such networks and the need for multiple termination points along a given network. For example, a fiber optic cable network can span over 150,000 kilometers, with termination points every 4-5 kilometers thereof. Some termination points require splicing the cable and an enclosure to protect the spliced cable from the surrounding environment.

Some cables (e.g., fiber optic cables) include an outer sheath with a protective layer comprising conductive material (e.g., a corrugated steel tape) and an inner sheath comprising a fibre, copper, aluminum, or composite core for power or data transmission. Connecting such cables to an enclosure generally involves some degree of bending the cable. However, bending the cable may cause the inner sheath to move relative to the outer sheath in an axial direction of the cable, a phenomenon known as “pistoning.” Pistoning may undesirably cause a spliced, exposed protective layer to emit a static electrical charge, creating a safety hazard to those in the vicinity of the enclosure. Some installers use heat shrink or potting resin to protect the spliced cable and prevent pistoning. However, these conventional methods require providing utilities (chemicals, a heat source) to the job site for bonding the heat shrink or resin to the cable, inconveniencing the installer. Moreover, such conventional methods require considerable time (e.g., 2-3 hours), increasing network installation cost, and may undesirably damage the core of the inner sheath. It is desirable to have a device that simplifies the installation of cable networks and prevents pistoning.

### SUMMARY

The following presents a simplified summary of the disclosure in order to provide a basic understanding of some example aspects described in the detailed description. This summary is not an extensive overview. Moreover, this summary is not intended to identify critical elements of the disclosure nor delineate the scope of the disclosure. The sole purpose of the summary is to present some concepts in simplified form as a prelude to the more detailed description presented later.

In accordance with one aspect, an anti-pistoning device comprises a body including a wall defining a first cavity and a second cavity, wherein the first cavity is configured to receive an outer sheath of a cable, and the second cavity is configured to receive an inner sheath of the cable.

In an embodiment, the body further comprises a first portion; and a second portion connected to the first portion, wherein at least one of the first and second portions is configured to pivot between a first state and a second state.

In an embodiment, the at least one of the first portion and the second portion is configure to pivot via a hinge connecting the first and second portions.

In an embodiment, the hinge comprises a living hinge.

In an embodiment, the body defines an internal lip extending in a direction orthogonal to a longitudinal axis of the body, wherein the lip and the wall at least partly define the first cavity.

In an embodiment, the lip is configured to engage a distal end of the outer sheath to electrically insulate the outer sheath.

In an embodiment, the wall includes an inner surface with a gripping element disposed thereon to increase static friction between the anti-pistoning device and the inner sheath or the outer sheath.

In an embodiment, a slot extends through the wall and extends in a longitudinal direction, said slot being configured to enable the body to radially contract when a clamping force is applied to the body.

In an embodiment, an outer surface of the wall defines a depression, said depression extending at least partially around a circumference of the body and dimensioned to receive a clamping element to clamp the anti-pistoning device to the cable.

In an embodiment, an outer surface of the wall defines a first depression adjacent a first end of the body, and a second depression adjacent a second end of the body, said first and second depressions being dimensioned to receive clamping elements to clamp the anti-pistoning device to the inner and outer sheaths.

In an embodiment, the body further comprises a first portion and a second portion connected to the first portion, wherein the first portion comprises a wall defining a first distal edge, and the second portion comprises a wall defining a second distal edge, wherein the first and second distal edges define a gap therebetween to receive the inner and outer sheaths therethrough in a first state.

In an embodiment, the first distal edge comprises a first mating element, and the second distal edge comprises a second mating element configured to mate with the first mating element.

In an embodiment, the first mating element comprises a leg, and the second mating element comprises a recess configured to receive the leg.

In an embodiment, at least one of the first portion and the second portion is configured to pivot from the first state to a second state to at least partially enclose the inner and outer sheaths.

In an embodiment, the at least one of the first and second portions is configured to pivot via a pivot pin or a hinge.

In accordance with another aspect, an anti-pistoning device comprises a body including a wall defining a first distal edge and a second distal edge, said first and second distal edges defining an opening therebetween proximate an end of the body, said opening being dimensioned to receive a cable therethrough to secure the body to the cable.

In an embodiment, the first distal edge defines a helical-shaped clip, said clip and the second distal edge defining the opening.

In an embodiment, the clip comprises an elastic material such that the clip is configured to flex outward when the cable is brought through the opening.

In an embodiment, the second distal edge defines a contour configured to guide the cable through the opening.

In an embodiment, an outer surface of the wall defines a depression extending at least partially around a circumference of the body, said depression being dimensioned to receive a clamping element thereon to clamp the anti-pistoning device to the cable.

In an embodiment, the body defines a first cavity and a second cavity, wherein the first cavity is dimensioned to receive an outer sheath of the cable, and the second cavity is dimensioned to receive an inner sheath of the cable.

It is to be understood that both the foregoing general description and the following detailed description present embodiments of the present disclosure, and are intended to provide an overview or framework for understanding the nature and character of the embodiments as they are described and claimed. The accompanying drawings are included to provide a further understanding of the embodiments, and are incorporated into and constitute a part of the specification. The drawings illustrate various embodiments of the disclosure and together with the description serve to explain the principles and operations thereof.

### BRIEF DESCRIPTION OF THE DRAWINGS

These and other features, aspects, and advantages of the present disclosure can be further understood when read with reference to the accompanying drawings:

FIG. 1 is a perspective view of an example anti-pistoning device according to a first embodiment;

FIG. 2 is another perspective view of the anti-pistoning device of FIG. 1, with the anti-pistoning device shown in a first state;

FIG. 3 is an exploded view of the anti-pistoning device of FIG. 1 shown with a hinge thereof removed for ease of illustration.

FIG. 4 is a perspective view of the anti-pistoning device of FIG. 1 shown disposed about a cable in a second state;

FIG. 5 is a cross-sectional view of the anti-pistoning device taken along plane 4-4 of FIG. 4;

FIG. 6 is a perspective view of the anti-pistoning device secured around a cable via example clamping devices according to embodiments;

FIG. 7 is a perspective view of the anti-pistoning device of FIG. 1 shown disposed about a cable with an earth strap attached thereto; and

FIG. 8 is a perspective view of another example anti-pistoning device according to a second embodiment.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. Whenever possible, the same reference numerals are used throughout the drawings to refer to the same or like parts. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Herein, the terms “substantially,” “about,” and variations thereof are intended to note that the described features are equal or approximately equal to a value as desired, for example, a value that is exact, within 10% of exact, or within 5% of exact, etc.

As used herein, the term “pistoning” is intended to denote the independent movement of one sheath of a cable relative to another sheath of the cable in an axial direction of the cable.

Embodiments herein relate to an anti-pistoning device configured to preclude the possibility of creating an electrical shock hazard while preventing the pistoning of one or more sheaths (e.g., concentric layers) of a cable to which the anti-pistoning device will be secured. In general, the anti-pistoning device may include a body with a first end and a second end disposed about a longitudinal axis. The body may comprise a wall extending between the first and second ends, and an internal flange or lip extending in a radial direction orthogonal to the longitudinal direction. The wall and the lip may at least partly define a first cavity of the body. The first cavity may be shaped and dimensioned to receive and electrically insulate an outer sheath of a cable, for example, an exposed conductive cable armor. The wall may also define a second cavity of the body. The second cavity may be shaped and dimensioned to receive an inner sheath comprising one or more stands or fibers of the cable. A clamping device may be operable to exert a radial pressure or force about the wall to clamp or otherwise secure the inner and outer sheaths therein and inhibit the pistoning of one sheath relative to another. The clamping device may exert a constant force in a variable range and between a minimum and maximum clamping force without crushing or otherwise damaging the cable.

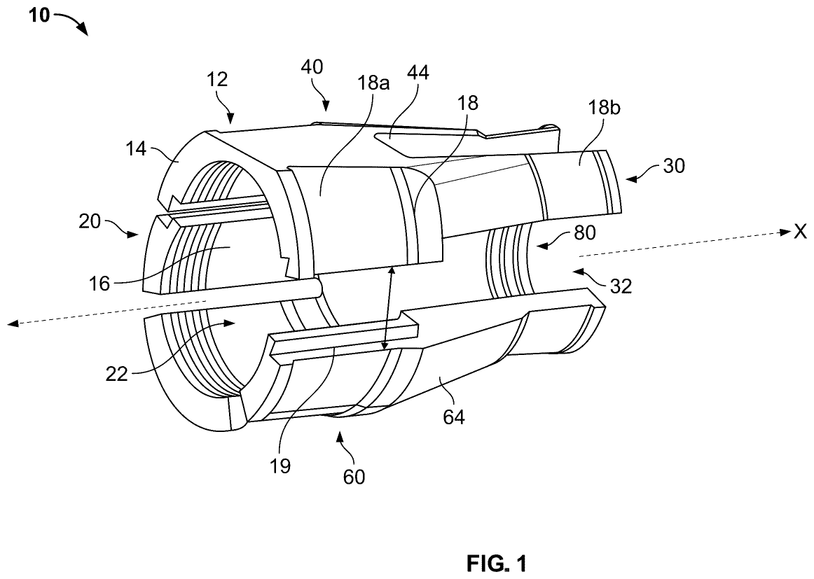

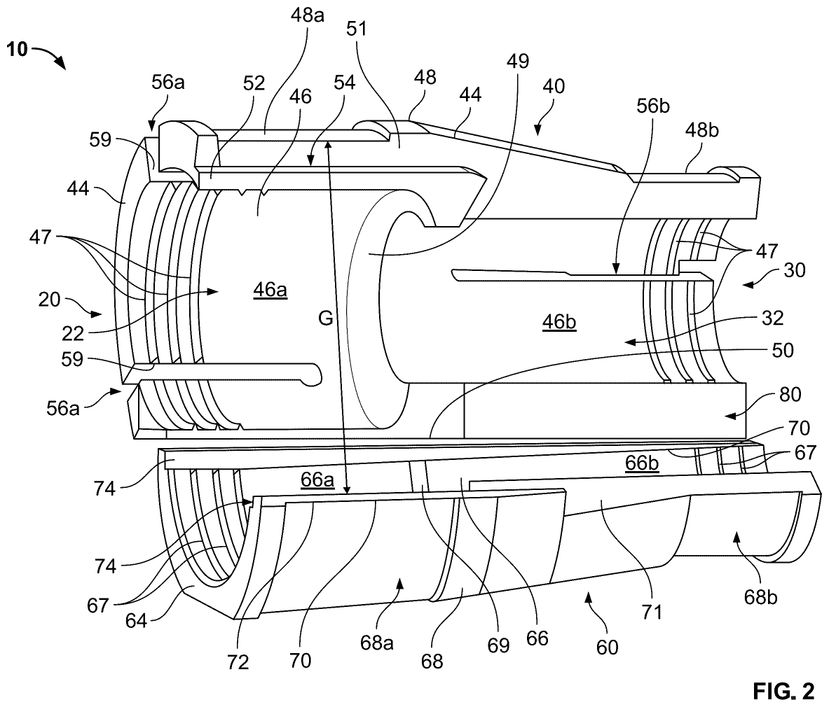

Referring to FIGS. 1 and 2, an anti-pistoning device 10 according to a first embodiment is shown. The anti-pistoning device 10 may include a body 12 with a first end 20 and a second end 30 disposed about a longitudinal axis x. The body 12 may comprise a suitable rubber or plastic injection molded material (or composite thereof). It is also contemplated that the body 12 may comprise a machined or casted metallic material.

The body 12 may include a wall 14 extending between the first and second ends 20 and 30. In the embodiment shown, the body 12 includes a first portion 40 and a second portion 60 comprising walls 44 and 64 respectively forming the wall 14 of the body 12. The walls 44 and 64 may be connected via a hinge (e.g., a living hinge such as a tag or tab made of flexible, polymeric (e.g., plastic), or rubber material) 80 to form a single, monolithic body (e.g., in embodiments wherein the body is a plastic-injected molded component). In this manner, the hinge 80 may demarcate the first and second portions 40 and 60 of the body 12. It is contemplated that the first and second portions 40 and 60 may be provided as separate components that are connected to form the body 12, for example, via a suitable connection means, e.g., a hinge, a pivot pin, magnets, conventional fasteners (including, but not limited to, screws, clips, resilient tabs dimensioned to be received by openings), and the like. In the embodiment shown, the first and second portions 40 and 60 are illustrated in an asymmetrical arrangement, whereby each portion is shaped and dimensionally different. It is contemplated that the first and second portions 40 and 60 can be provided in various shapes and forms, for example, to provide a symmetrical arrangement (each comprising a similar shape and dimension).

The wall 44 of the first portion 40 may define an inner surface 46 and an outer surface 48 spaced apart and connected via a proximal edge 50 and a distal edge 51. The proximal and distal edges 50 and 51 may define mating features configured to mate with mating features of the second portion 60. In the embodiment shown, the mating features define an elongated leg 52 protruding from the edge 51 that is shaped and dimensioned to mate with a corresponding, elongated recess 74 of the second portion 60. The outer surface 48 may define a first depression 48a and a second depression 48b extending about at least a partial circumference of the first portion 40.

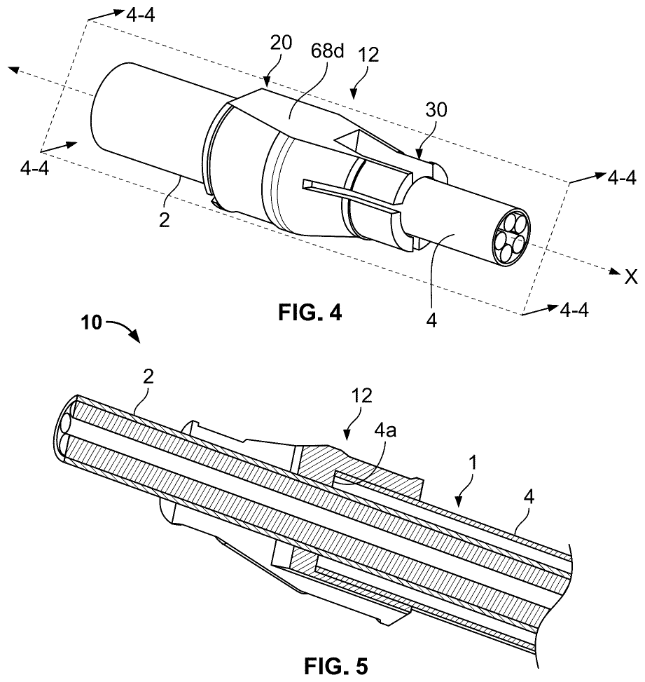

The inner surface 46 may comprise a first inner surface 46a and a second inner surface 46b demarcated by an internal flange or lip 49. The lip 49 may connect the first and second inner surfaces 46a and 46b of the first portion 40 and define a face extending in a radial direction orthogonal to the longitudinal axis x. The lip 49 may define a stop for an outer sheath 4 (FIGS. 4 and 5) of a cable 1 and provide an insulating function therefor, as discussed in detail below.

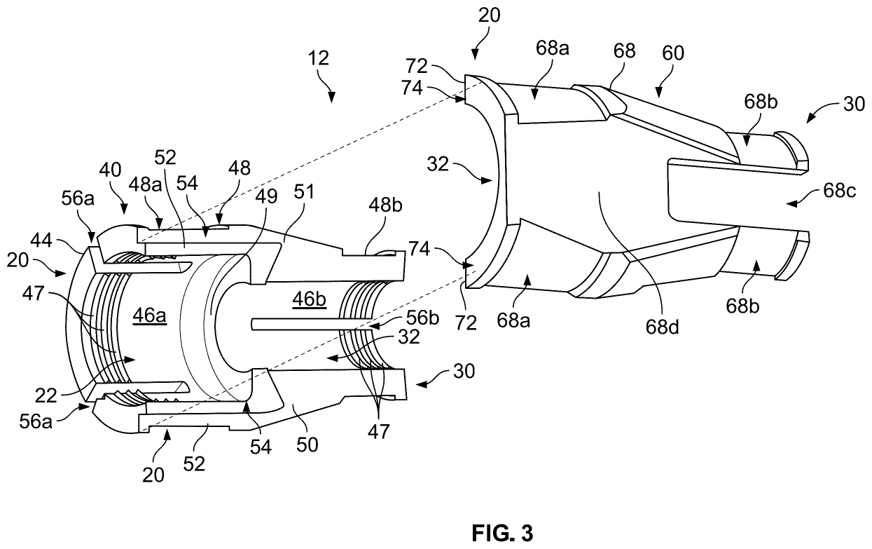

Referring to FIGS. 2 and 3, a plurality of protrusions 47 may extend from the first and second inner surfaces 46a and 46b to define gripping elements of the first portion 40 configured to grip outer and inner sheaths 4 and 2 (FIGS. 4 and 5) of the cable 1. A plurality of slots 56a and 56b may extend longitudinally and between the inner and outer surfaces 46 and 48 of the first portion 40. The slots 56a and 56b may be dimensioned to enable the body 12 of the anti-pistoning device 10 to contract in a radial direction around the outer and inner sheaths 4 and 2 of the cable 1. In the embodiment shown, there are two slots 56a extending longitudinally and disposed adjacent to the first end 20, and one slot 56b extending longitudinally and disposed adjacent to the second end 30. It is contemplated that the first portion 40 may comprise a different arrangement and number of slots, for example, one slot or more than two slots adjacent to the first end 20, and more than one slot adjacent to the second end 30. It is also contemplated that the width and the length of the slots may differ from that which is shown, for example, to accommodate a predetermined degree of radial contraction for a specific application, e.g., based on factors, including, but not limited to, the cable diameter, a maximum degree of contraction corresponding with a maximum clamping force (e.g., an upper limit), the type of cable (e.g., and the core therein), and the like.

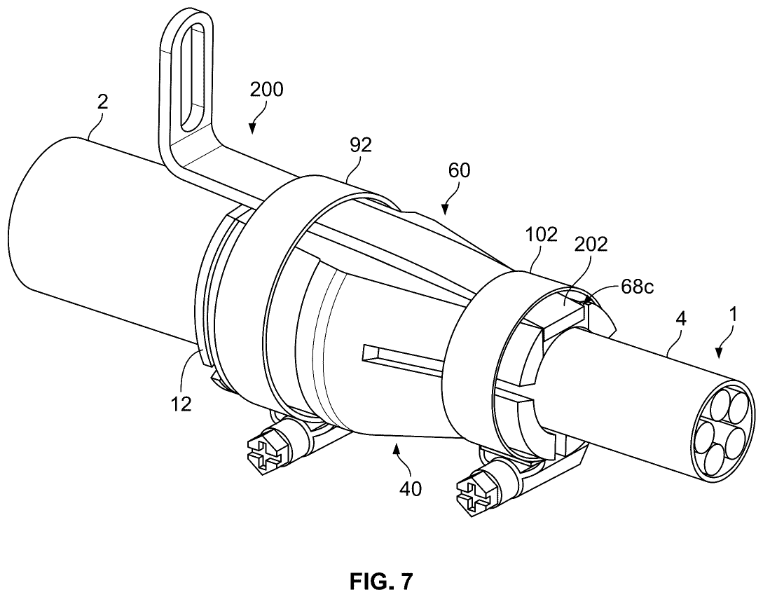

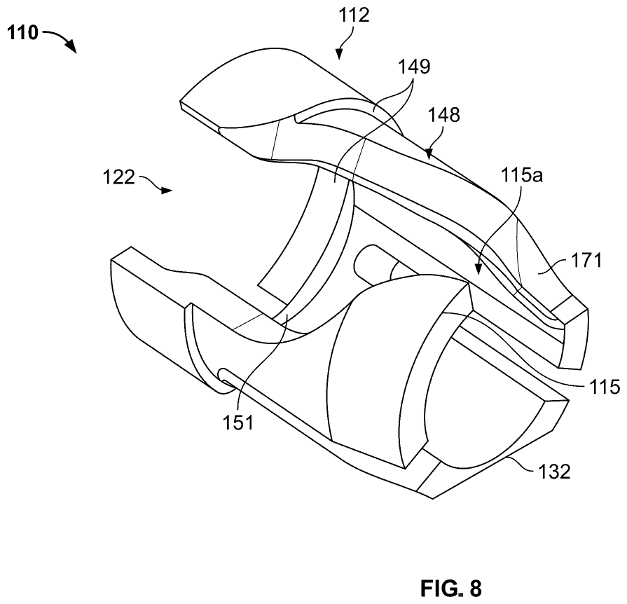

The second portion 60 of the body 12 may include similar features as the first portion 40. For example, the wall 64 of the first portion 60 may define an inner surface 66 and an outer surface 68 spaced apart and connected via a proximal edge 70 and a distal edge 71. The proximal and distal edges 70 and 71 may define mating features configured to mate with the mating features of the first portion 40. In the embodiment shown, the mating features define a leg 72 protruding from the edge 71 that is shaped and dimensioned to mate with the corresponding recess 54 of the first portion 40. A pass-through opening 68c may extend between the inner surface 66 and the outer surface 68 adjacent the second end 30. The opening 68c may be dimensioned to receive a distal end 202 of an earth strap or grounding strap 200 (FIG. 7), as discussed in detail below.

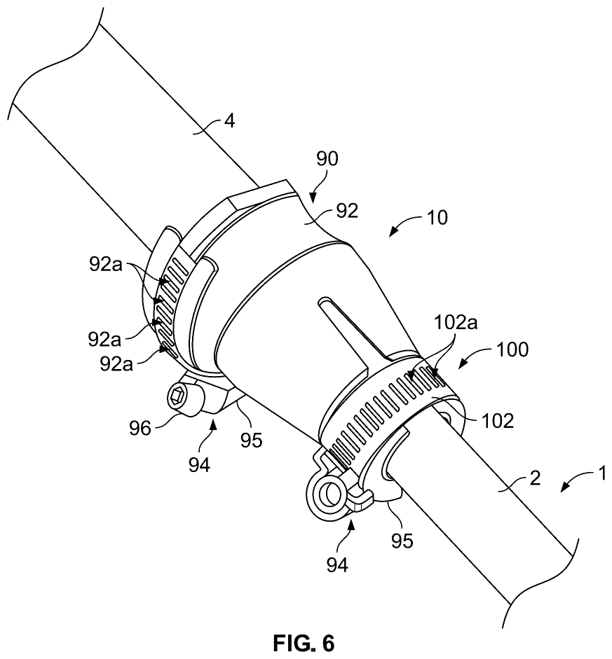

The outer surface 68 may define a first depression 68a and a second depression 68b extending about at least a partial circumference of the second portion 60. As shown in FIG. 5, the outer surface 68 may also define a chamfered-like, planar surface 68d configured to define a mounting surface for a housing of a clamping device (e.g., 90 in FIG. 6), as discussed below.

The inner surface 66 may comprise a first inner surface 66a and a second inner surface 66b demarcated by an inner flange or lip 69. The lip 69 may connect the first and second inner surfaces 66a and 66b of the first portion 40 and define a face extending in a radial direction orthogonal to the longitudinal axis x. The lip 69 may define a stop for the outer sheath 4 (FIGS. 4 and 5) of a cable and provide insulation therefor, as discussed in detail below.

Referring to FIGS. 2 and 3, a plurality of protrusions 67 may extend from the first and second inner surfaces 66a and 66b to define gripping elements of the second portion 60 configured to grip the outer and inner sheaths 4 and 2 (FIGS. 4 and 5) of the cable 1.

Referring to FIGS. 1-5, the anti-pistoning device 10 will now be described with respect to securing the anti-pistoning device 10 to a cable 1 with exposed inner and outer sheaths 2 and 4. As noted above, the first and second portions 40 and 60 may collectively form the body 12. In this manner, the inner surfaces 46 and 66 of the first and second portions 40 and 60 may collectively define an inner surface 16 of the body 12, and the outer surfaces 48 and 69 thereof may collectively define an outer surface 18 of the body 12. Additionally, the internal lips 49 and 69 of the first and second portions 40 and 60 may define an internal lip 19 of the body 12. Further still, the first and second depressions 48a, 68a and 48b, 68b may collectively define first and second depressions 18a and 18b of the body 12, and the inner surface 16 of the wall 14 of the body 12 and the internal lip 19 may define a first cavity 22, and the inner surface 16 of the wall 14 may define a second cavity 32, respectively.

One or both of the first and second portions 40 and 60 may be configured to pivot or otherwise be moved (e.g., via the hinge 80) between a first state (e.g., an open state—FIG. 2) and a second state (e.g., a closed state—FIGS. 1 and 3), with the longitudinal axis x defining a radial center of the body 12. In the first state (FIG. 2), the distal edges 51 and 71 of the first and second portions 40 and 60 may be spaced apart to define a gap G dimensioned to allow a user to wrap the anti-pistoning device 10 around a cable 1 (FIG. 3) to which it will be secured. Because the living hinge 80 may connect the first and second portions 40 and 60 of the body 12, the anti-pistoning device 10 is configured to simplify installation by enabling an installer to handle a single component (i.e., a single body 12) around the cable 1, instead of handling and securing two disconnected components around the cable 1, which may be more susceptible to being dropped by the installer (increasing installation time).

Specifically, in the first state (FIG. 2), the cable 1 may be brought into the body 12 (e.g., via the gap G) such that the outer sheath 4 (FIGS. 4 and 5) is received by the first cavity 22, and the inner sheath 2 is received by the second cavity 32. In this manner, the first cavity 22 may be shaped and dimensioned such that it will substantially conform to an external contour of the outer sheath 4 in the second state. Likewise, the second cavity 32 may be shaped and dimensioned such that it will substantially conform to an external contour of the inner sheath 2 in the second state.

A distal end 4a (FIG. 5) of the outer sheath 4 may be brought into an abutting engagement with the internal lip 19 (i.e., collectively defined by lips 49 and 69). In this manner, the internal lip 19 may define a stop to preclude the outer sheath 4 from axial movement in a rearward direction (i.e., in an axial direction extending toward the inner sheath 2). Bringing the outer sheath 4 into contact with the internal lip 19 may also serve to provide tactile feedback to confirm that the outer sheath 4 has been fully received by the first cavity 22, such that the lip 19 may provide an insulating function, as discussed below.

When the outer and inner sheaths 4 and 2 are received by the first and second internal cavities 22 and 32, then one or both of the first and second portions 40 and 60 may be pivoted or moved to the second state such that distal edges 51 and 71 thereof are brought closer to one other (decreasing the gap G (FIG. 2)) until the leg 52 of the first portion 40 is received by (e.g., interlocks with) the recess 74 of the second portion 60, and the leg 72 of the second portion 60 is received by the recess 54 of the first portion 40.

In the second state, first and second clamping devices may be disposed about the body 12 to secure the anti-pistoning device to the cable 1. For example, referring to FIG. 6, a first clamping device 90 may comprise a clamping element 92 (e.g., a band, strap, coil, tie, wire, conduit, or clip) that is dimensioned to be received by and extended around the first depression 18a of the body 12, and a second clamping device 100 may comprise a clamping element (e.g., a band, strap, coil, tie, wire, conduit, or clip) or strap 102 dimensioned to be received by and wrapped around the second depression 18b of the body 12. In addition, the first and second clamping devices 90 and 100 may each comprise an actuator 94 operable to increase tension in the first and second clamping elements 92 and 102, causing the clamping elements 92 and 102 to exert a radial pressure or force to the body, respectively, to clamp the anti-pistoning device 10 to the cable 1 (e.g., to tighten the clamping elements around the body). In some embodiments, the actuators 94 may comprise a variable operating range, for example, defined by a lower limit (i.e., a minimal clamping force) and an upper limit (i.e., a maximum clamping force). For example, the first and second clamping devices 90 and 100 may embody worm drive clamps (as shown), with the clamping elements 92 and 102 (e.g., straps) thereof defining a plurality of slots 92a and 102a dimensioned to engage fasteners 96 (i.e., comprising worms) secured to housings 95 of the clamping devices 90 and 100. In this manner, any suitable tool (e.g., a screw driver, a socket wrench, or power tool comprising an appropriate bit) may be brought into engagement with each fastener 96 to increase or decrease the tension in the clamping elements 92 and 102 (i.e., between a minimal clamping force and a maximum clamping force). In some embodiments, the clamping elements 92 and 102 may be provided with a predetermined number of slots 92a and 102a to inhibit an installer from increasing tension in the clamping elements beyond a maximum, clamping force to preclude the clamping devices 90 and 100 from being used in a manner that would otherwise crush or damage the cable. For example, clamping elemeent 92 may comprise a first plurality of slots defining a first maximum clamping force for the outer sheath 4, and clamping element 102 may comprise a second plurality of slots defining a second maximum clamping force for the inner sheath 2. Referring to FIG. 7, in some embodiments, the anti-pistoning device 10 may be used with a ground strap or earth strap 200 attached to the body 12 thereof. In particular, a distal end 202 of the earth strap 200 may be received by the pass-through opening 68c of the second portion 60 of the body 12. In this configuration, the clamping elements 92 and 102 may be wrapped around the earth strap or ground strap 200 and tightened to secure the earth strap 200 in place. This aspect of the present disclosure beneficially allows for a controlled contact between the earth strap 200 and the cable 1. Moreover, it also improves increases stability, by preventing the clamping elements 92 and 102 from moving or turning relative to the body 12.

Referring to FIG. 6, when the clamping devices 90 and 100 are operated to increase the clamping force, the radial pressure exerted on the outer and inner sheaths 4 and 2 will increase the static friction between the anti-pistoning device and the inner and outer sheaths 4 and 2. This aspect of the present disclosure is particularly beneficial to inhibit the inner and outer sheaths 2 and 4 from pistoning, for example, if the cable is bent during installation thereof (e.g., when installing the cable in a telecom or power junction box).

Moreover, increasing the clamping force will cause the gripping elements 47 and 67 to grip or otherwise engage the inner and outer sheaths 2 and 4, further increasing the static friction between the anti-pistoning device and the cable 1 to inhibit pistoning. In some embodiments, the gripping elements 47 may be replaced or supplemented by an impediment surface (e.g., a resilient, high friction material such as rubber or silicone) applied to the inner surface 16 of the body 12). Optionally or alternatively, a knurled pattern may be formed on the inner surface 16 of the body 12 to increase the static friction between the inner and outer sheaths 2 and 4 and the anti-pistoning device 10.

Further still, the slots 56a and 56b in the body 12 will enable the body 12 to radially contract as the clamping force is increased via the clamping elements 92 and 102. This aspect of the present disclosure is particularly beneficial to allow the body 12 to accommodate inner and outer sheaths 2 and 4 of varying diameters. For example, the body 12 may contract to a lesser degree when receiving inner and outer sheaths 2 and 4, having a larger diameter, versus inner and outer sheaths 2 and 4, having a smaller diameter.

In some embodiments, the slots 56a and 56b (and width thereof) may be dimensioned to preclude the body 12 from radially contracting beyond a predetermined threshold (e.g., corresponding with the maximum clamping force) to preclude damaging or crushing the inner core of the cable 1 (i.e., the fibers or strands therein). In some embodiments, one or more protrusions 59 (FIG. 2) may extend into the slots 56a and 56b to define a limit or stop to preclude the width of the slots 56a and 56b from contracting beyond the predetermined threshold.

As noted above, the inner lip 49 (abutting the outer sheath 4) of the anti-pistoning device 10 may provide an insulating function, for example, in such embodiments where the outer sheath 4 comprises an exposed, conductive material (e.g., a corrugated metal armour). Specifically, the lip 49 may insulate the conductive material when it is an abutting arrangement therewith, and may comprise any suitable insulating material for this purpose (e.g., a rubber or polymeric material). This aspect of the present disclosure is particularly beneficial to preclude the possibility that an electrical static discharge could create a potential safety hazard for a person in the vicinity of the cable 1 (e.g., a person placing their hand inside an enclosure).

In the embodiment shown, the clamping devices 90 and 100 embody worm drive clamps. It is contemplated that a variety of different clamping devices may be used for clamping the anti-pistoning device 10 to the inner and outer sheaths 2 and 4 of the cable 1. For example, the clamping devices 90 and 100 may comprise any suitable example of a hose clamp or wire hose tensioner (e.g., a flat spring wire hose tensioner operable to provide a uniform clamping force) operable to increase tension in the clamping elements 92 and 102. In some embodiments, the clamping devices 90 and 100 may embody spring-tension clamps, constant-tension band clamps or clips, or any other known suitable example thereof configured to expand or contract in response to temperature changes to provide a uniform clamping force. In some embodiments, the clamping devices 90 and 100 may comprise zip ties to tighten or otherwise secure the anti-pistoning device 10 outer and inner sheaths 4 and 2. For this purpose, a pneumatic zip tie gun may be utilized for this purpose. It is also contemplated that the clamping devices 90 and 100 may utilize wire ties or other forms of flexible wires (e.g., automotive wires) as clamping elements 92 and 102.

In any such embodiment, only one tool (e.g., a wrench, screwdriver, power tool) may be needed to fasten or otherwise secure the clamping devices 90 and 100 to the anti-pistoning device 10. This aspect of the present disclosure is particularly beneficial in reducing installation time (e.g., to about 1-10 minutes per anti-pistoning device, for example, about 3 minutes) and the requirement for multiple different tools and/or utilities needed for installing a cable network. This is in contrast to current known solutions, requiring various tools and utilities (e.g., heating torches, industrial gas, bonding chemicals, potting resin, etc.) to insulate the cable and prevent pistoning, which also require considerably more time (e.g., 2-3 hours) than that made possible via the present disclosure.

Moreover, it should be understood that the body 12 (e.g., the first cavity 22 and the second cavity 32) of the anti-pistoning device 10 may be dimensioned for a variety of applications, based on varying cable dimensions (i.e., inner and outer sheath diameters). For example, it is contemplate that the anti-pistoning device may be dimensioned to accommodate cables having diameters between about 1 mm to about 70 mm. Likewise, it is contemplated that the anti-pistoning device 10 may take on a variety of different shapes and forms. For example, referring to FIG. 7, another example of an anti-pistoning device 110 is shown. The anti-pistoning device 110 may comprise features similar to those described above, with respect to the anti-pistoning device 10. Therefore, a description of similar features has been omitted for brevity, except for the following differences.

In the illustrated example, the anti-pistoning device 110 comprise a body 112 with a first distal edge 151 and a second distal edge 171 extending in a longitudinal direction. The first distal edge 151 may define a helical-shaped clip 115 configured to wrap around the inner sheath 2 (FIG. 6) of the cable 1 and snap into place to secure the inner sheath 2 thereto. In use, the inner sheath 2 may be brought into the second cavity 132 of the body 112 via an opening 115a between the helical clip 115 and the second distal edge 171 of the body 112. The second distal edge 171 may be shaped and dimensioned to facilitate guiding the inner sheath 2 through the opening 115a. For example, in the embodiment shown, the second distal edge 171 may define an inclined, helical contour (e.g., a ramp) to help guide the inner sheath 2 through the opening 115a, causing the inner sheath 2 to urge the helical clip 115 outward (during insertion), until the inner sheath 2 is received by the second cavity 132. When received, the helical clip 115 may snap back into place to secure the anti-pistoning device 110 to the cable 1. For this purpose, the body 112 may comprise a resilient, elastic material (e.g., any suitable elastic polymer or rubber-based material). When the inner sheath 2 is received by the second cavity 132, the anti-pistoning device may be urged or pulled backward (e.g., in an axial direction toward the outer sheath 4), causing the outer sheath 4 to be received by the first cavity 122 until it contacts the inner lip 149 thereof (e.g., such that the inner lip 149 may provide an insulating function, and define a mechanical stop (to preclude the outer sheath 4 from being pulled any further). In the embodiment shown, the body 112 defines a single depression 148 to receive a clamping element of a clamping device (any suitable form disclosed herein) to secure the anti-pistoning device 110 to the cable 2. It is contemplated that the body 112 may define more than one depression.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of an anti-pistoning device. Modifications may occur to those skilled in the art and to those who may make and use the invention. The disclosed embodiments are merely for illustrative purposes and not intended to limit the scope of the invention or the subject matter set forth in the claims.

What is claimed is:

1. An anti-pistoning device comprising:
a body including a wall defining a first cavity and a second cavity, wherein the first cavity is configured to receive an outer sheath of a cable, and the second cavity is configured to receive an inner sheath of the cable.

2. The anti-pistoning device of claim 1, wherein the body further comprises:
a first portion; and
a second portion connected to the first portion, wherein at least one of the first and second portions is configured to pivot between a first state and a second state.

3. The anti-pistoning device of claim 2, wherein the at least one of the first portion and the second portion is configure to pivot via a hinge connecting the first and second portions.

4. The anti-pistoning device of claim 3, wherein the hinge comprises a living hinge.

5. The anti-pistoning device of claim 1, wherein the body defines an internal lip extending in a direction orthogonal to a longitudinal axis of the body, wherein the lip and the wall at least partly define the first cavity.

6. The anti-pistoning device of claim 5, wherein the lip is configured to engage a distal end of the outer sheath to electrically insulate the outer sheath.

7. The anti-pistoning device of claim 1, wherein the wall includes an inner surface with a gripping element disposed thereon to increase static friction between the anti-pistoning device and the inner sheath or the outer sheath.

8. The anti-pistoning device of claim 1, wherein a slot extends through the wall and extends in a longitudinal direction, said slot being configured to enable the body to radially contract when a clamping force is applied to the body.

9. The anti-pistoning device of claim 1, wherein an outer surface of the wall defines a depression, said depression extending at least partially around a circumference of the body and dimensioned to receive a clamping element to clamp the anti-pistoning device to the cable.

10. The anti-pistoning device of claim 1, wherein an outer surface of the wall defines a first depression adjacent a first end of the body, and a second depression adjacent a second end of the body, said first and second depressions being dimensioned to receive clamping elements to clamp the anti-pistoning device to the inner and outer sheaths.

11. The anti-pistoning device of claim 1, wherein the body further comprises a first portion and a second portion connected to the first portion, wherein the first portion comprises a wall defining a first distal edge, and the second portion comprises a wall defining a second distal edge, wherein the first and second distal edges define a gap therebetween to receive the inner and outer sheaths therethrough in a first state.

12. The anti-pistoning device of claim 11, wherein the first distal edge comprises a first mating element, and the second distal edge comprises a second mating element configured to mate with the first mating element.

13. The anti-pistoning device of claim 12, wherein the first mating element comprises a leg, and the second mating element comprises a recess configured to receive the leg.

13. The anti-pistoning device of claim 11, wherein at least one of the first portion and the second portion is configured to pivot from the first state to a second state to at least partially enclose the inner and outer sheaths.

14. The anti-pistoning device of claim 13, wherein the at least one of the first and second portions is configured to pivot via a pivot pin or a hinge.

15. An anti-pistoning device comprises:
a body including a wall defining a first distal edge and a second distal edge, said first and second distal edges defining an opening therebetween proximate an end of the body, said opening being dimensioned to receive a cable therethrough to secure the body to the cable.

16. The anti-pistoning device of claim 15, wherein the first distal edge defines a helical-shaped clip, said clip and the second distal edge defining the opening.

17. The anti-pistoning device of claim 16, wherein the clip comprises an elastic material such that the clip is configured to flex outward when the cable is brought through the opening.

18. The anti-pistoning device of claim 15, wherein the second distal edge defines a contour configured to guide the cable through the opening.

19. The anti-pistoning device of claim 15, wherein an outer surface of the wall defines a depression extending at least partially around a circumference of the body, said depression being dimensioned to receive a clamping element thereon to clamp the anti-pistoning device to the cable.

20. The anti-pistoning device of claim 15, wherein the body defines a first cavity and a second cavity, wherein the first cavity is dimensioned to receive an outer sheath of the cable, and the second cavity is dimensioned to receive an inner sheath of the cable.
